(19) United States
(12) Patent Application Publication
(10) Pub. No.: US 2020/0039505 A1
(43) Pub. Date: Feb. 6, 2020

(54) METHOD AND SYSTEM FOR DETERMINING A FORDING SITUATION

(71) Applicant: Robert Bosch GmbH, Stuttgart (DE)

(72) Inventor: Jesse Sharp, Caulfield North VIC (AU)

(21) Appl. No.: 16/520,470

(22) Filed: Jul. 24, 2019

(30) Foreign Application Priority Data
Jul. 31, 2018 (DE) 102018212787.5

(51) Int. Cl. B60W 30/04; B60W 10/06; B60W 40/06

(52) U.S. Cl. CPC B60W 30/04; B60W 10/06; B60W 40/06; B60W 30/18018; B60W 2520/18; B60W 2520/26; B60W 2520/28; B60G 2500/30

(57) ABSTRACT

A driver assistance system includes a first measuring device for determining distances from a water surface, which includes at least two distance sensors. First and second distance sensors are situated laterally on the vehicle with respect to a respective side of the vehicle. The first and second distance sensor measure a first distance from a water surface by determining the distance perpendicularly downward from the respective sensor to the water surface. The system includes a second measuring device for determining an instantaneous roll angle of the vehicle and a processing unit, which is coupled to the first measuring device and to the second measuring device. The processing unit determines at least one first transversal component of the instantaneous flow velocity of the body of water forming the water surface, as a function of the first distance, the second distance and the instantaneous roll angle of the vehicle.

### CROSS REFERENCE

The present application claims the benefit under 35 U.S.C. § 119 of German Patent Application No. DE 102018212787.5 filed on Jul. 31, 2018, which is expressly incorporated herein by reference in its entirety.

### FIELD

The present invention relates to a driver assistance system and to a method for determining a fording situation, and to a vehicle including a driver assistance system according to the present invention, it being possible to determine at least one component of a flow velocity of a body of water being negotiated by the vehicle.

### BACKGROUND INFORMATION

Off-road vehicles, such as all-terrain vehicles or so-called SUVs (“sport utility vehicles”), are designed to cross bodies of water. When the vehicle has to become immersed in the water to a certain degree in the process, this is referred to as a “fording process”. Such a maneuver requires a lot of caution and prudence from the driver, since the driver usually does not know how deep the body of water is he or she would like to cross, or what the condition of the terrain beneath the water surface is. This problem is further exacerbated by adverse environmental conditions such as darkness, fog, rain or dirty water. Conventionally, the recommendation has been for the driver to leave the vehicle prior to crossing the body of water and to check the water depth and the terrain conditions beneath the water surface using suitable aids.

Assistance systems which make it simpler for the driver to handle a fording process are known from the related art. For example, a vehicle is described in PCT Application No. WO 2012/123555 A1 which includes two ultrasonic sensors, which are each attached to the side mirrors of the vehicle and which detect the distance from a water surface beneath the side mirrors, and a water contact sensor situated on the underbody of the vehicle.

PCT Application Nos. WO 2012/080435 A1, WO 2012/080437 A1 and WO 2012/080438 A1 describe vehicles which include display systems representing a side view of the vehicle, together with a measured instantaneous fording depth and a maximum permissible fording depth (fording limit). The instantaneous fording depth and the fording limit are each shown as straight lines. The maximum fording limit, i.e., the fording limit, usually results from design characteristics of the particular vehicle. For example, air intakes of an internal combustion engine must not end up underwater. It is possible to display to the driver by a percentage value how deep the vehicle is presently situated under water in relation to the fording limit.

The present invention is aimed at gathering more precise pieces of information about the instantaneous fording situation of a vehicle, so that more precise pieces of information about the instantaneous fording situation are made available to the driver, which include, in particular, a lateral current of the body of water. The fording situation denotes the instantaneous position of the vehicle relative to a water surface into which the vehicle at least partially immerses. The fording situation is characterized, for example, by the fording depth, the pitch of the ground and/or an inclination of the vehicle in the longitudinal direction and/or in the transversal direction relative to the horizontal.

### SUMMARY

The above-mentioned object may be achieved by a driver assistance system and by a method for determining a fording situation of a vehicle.

Preferred refinements of the present invention are described herein.

In accordance with the present invention, while stagnant bodies of water have an essentially horizontal surface, which is oriented perpendicularly to the direction of gravitation, moving bodies of water cause an increase in the water level on the side of a vehicle crossing the body of water which faces the flow vector, even in the case of very minor slopes. The greater the flow velocity, the greater is the difference compared to the water level on the side of the vehicle facing away from the flow vector. The cause of this is that the vehicle retains the body of water to a certain degree, in particular, when it is moving transversely or perpendicularly to the flow direction of the body of water. Such a situation typically occurs when a river or creek is being crossed.

According to the present invention, this effect is to be utilized to determine an instantaneous flow velocity of the body of water. The greater the flow velocity, the greater is the difference between the measured distance from the water surface on the side of the vehicle facing the current and the measured distance from the water surface on the side of the vehicle facing away from the current.

According to a first aspect of the present invention, a driver assistance system is provided, which is designed to determine such a fording situation of a vehicle. The driver assistance system includes a first measuring device for determining distances from a water surface, which includes at least two distance sensors. A first distance sensor is designed to be situated laterally on the vehicle with respect to a first side of the vehicle. A second distance sensor is designed to be situated laterally on the vehicle with respect to a second side of the vehicle, the second side being situated opposite the first side. The first distance sensor is designed to measure a first distance from a water surface, in particular, by determining the distance perpendicularly downward from the first sensor to the water surface, and the second distance sensor is designed to measure a second distance from a water surface, in particular, by also determining the distance perpendicularly downward from the second sensor to the water surface. The first distance sensor and the second distance sensor are preferably each designed as ultrasonic sensors. The respective installation height of the first and second distance sensors relative to the vehicle is, in particular, known or established. The first distance sensor and the second distance sensor may be situated, for example, on the side mirrors of the vehicle. In the determination of the first and second distances, different installation heights of the distance sensors may be considered, if necessary.

Furthermore, the driver assistance system includes a second measuring device for determining an instantaneous roll angle of the vehicle. The roll angle describes the transversal inclination of a transverse axis of the vehicle relative to the horizontal plane. The second measuring device may encompass an acceleration sensor, a gyroscope or a spirit level, for example.

Furthermore, the driver assistance system includes a processing unit, which is coupled to the first measuring device and the second measuring device. The processing unit is designed to determine a first component of the instantaneous flow velocity of the body of water forming the water surface, perpendicular to the side of the vehicle facing the flow direction, as a function of the first distance, of the second distance and of the instantaneous roll angle of the vehicle. This component of the flow velocity may also be referred to as transversal component.

The term ‘side of the vehicle’ refers to a lateral surface of the vehicle.

In one preferred embodiment of the present invention, the driver assistance system additionally includes a third measuring device for determining an instantaneous pitch angle of the vehicle. The processing unit is additionally coupled to the third measuring device and designed to take the instantaneous pitch angle of the vehicle into consideration in the determination of the instantaneous flow velocity. In this way, the actual instantaneous orientation of the vehicle relative to a horizontal plane is advantageously included in the determination of the flow velocity, resulting in increased accuracy.

In one particularly preferred embodiment, the first measuring device additionally includes a third distance sensor and a fourth distance sensor, the third distance sensor being designed to be situated on a front of the vehicle, in particular, on a front bumper, and the fourth distance sensor being designed to be situated on the rear of the vehicle, in particular, on a rear bumper. The third distance sensor is designed to measure a third distance from a water surface, and the fourth distance sensor is designed to measure a fourth distance from a water surface. The processing unit is designed to determine a second, in particular longitudinal, component of the instantaneous flow velocity of the body of water forming the water surface, as a function of the third distance, of the fourth distance and of the instantaneous pitch angle of the vehicle. The longitudinal component denotes the vector component of the flow velocity in the driving direction or in the direction of the geometric longitudinal axis of the vehicle. Particularly preferably, the longitudinal component of the flow velocity may be determined in this way at relatively low water depths, compared to the installation height of the third and fourth distance sensors, so that the third and fourth distance sensors are not yet flooded. Furthermore, the longitudinal component of the flow velocity may preferably be determined at relatively low vehicle speeds or with the vehicle stationary, so that preferably low perturbations occur from the vehicle movement. Thus, a vehicle which is moving through a body of water, for example, usually causes a bow wave in its front region. This could influence the measurement of the third distance, for example, but also of the first and second distances. This may, for example, be resolved with the aid of a table in which the effects of a bow wave on the respective distance measurements are stored for various speeds, so that the corresponding distance measurement may be corrected.

This embodiment makes it possible to determine two velocity components of the flow velocity of the body of water relative to the vehicle. As a result of the piece of information on which of the sides of the vehicle in each case a distance lower than on the respective opposite side has been measured, the flow direction may preferably also be determined. In this way, advantageously detailed pieces of information about the fording situation, including a direction and strength of a water current, are available, which may be utilized when carrying out the fording process to further increase the safety and the comfort for the driver and/or the occupants of the vehicle.

Furthermore, the driver assistance system preferably includes a memory unit. A table is stored in this memory unit, in which assigned flow velocities are stored for a multitude of combinations of possible measured values for the first distance and the second distance. As an alternative or in addition, the table may include assigned flow velocities for a multitude of combinations of possible measured values for the third distance and the fourth distance. As an alternative or in addition, the table may include assigned velocity values for a water current for a multitude of difference values of the respective distances measured on opposing sides of the vehicle.

A difference value may be understood to mean the difference between the first distance and the second distance, or the difference between the third and fourth distances. If necessary, different installation heights of the distance sensors may be considered in the process.

These tables may, in particular, be specifically provided for a certain vehicle type. The measured values of the distances and/or the difference values may refer to a horizontal orientation (pitch angle and roll angle each equal to zero). At a deviating pitch angle and/or roll angle, the measured values may initially be standardized to a horizontal orientation of the vehicle, before a corresponding value for the flow velocity is read out from the table.

With the aid of such a table, an absolute velocity value for at least one component of the current may be determined from the measured distances quickly and without increased computing effort. Complex calculations are not needed. The table has to be created only once, e.g., specifically for a certain vehicle type. This may take place, e.g., by carrying out test measurements in a test environment, using a flow measuring device and/or with the aid of model calculations.

The driver assistance system preferably includes a warning unit, the processing unit being designed to compare an absolute value of a previously determined component of the instantaneous flow velocity to a velocity threshold value, and the warning unit being designed to output a warning as a function of the comparison. In this way, the driver may be given a timely warning when a body of water having a high flow velocity is being crossed, and there is the risk of the vehicle being carried away.

The velocity threshold value, starting at which the driver is given a warning, is preferably predefined as a function of an instantaneous fording depth and/or as a function of an instantaneous driving speed and/or of a driving direction of the vehicle. As an alternative or in addition, the vehicle type and/or the roll angle and/or the pitch angle may also be incorporated in the velocity threshold value.

According to another aspect of the present invention, a vehicle is provided which includes a driver assistance system as described above.

Preferably, the first distance sensor and the second distance are each situated on a side mirror of the vehicle, in particular, in such a way that they are able to measure the distance from a water surface perpendicularly downward. The respective installation height of the first and second distance sensors on the vehicle is, in particular, known or established.

According to another aspect of the present invention, a method for determining a fording situation of a vehicle is provided, the vehicle including a first measuring device for determining distances from a water surface, including at least two distance sensors. A first distance sensor is designed to be situated laterally with respect to a first side of the vehicle. A second distance sensor is designed to be situated laterally with respect to a second side of the vehicle, the second side being situated opposite the first side. The vehicle includes a second measuring device for determining an instantaneous roll angle of the vehicle.

With the aid of the first distance sensor, a first distance from a water surface is measured. With the aid of the second distance sensor, a second distance from a water surface is measured. According to the present invention, at least one first, in particular transversal, component of the instantaneous flow velocity of the body of water forming the water surface is determined, as a function of the first distance, of the second distance and of the instantaneous roll angle of the vehicle.

Preferably, the vehicle includes a third measuring device for determining an instantaneous pitch angle of the vehicle, at least one component of the instantaneous flow velocity being determined as a function of the instantaneous pitch angle.

In one preferred embodiment of the method, the first measuring device additionally includes a third distance sensor and a fourth distance sensor, the third distance sensor being designed to be situated on a front of the vehicle, in particular, on a front bumper, and the fourth distance sensor being designed to be situated on the rear of the vehicle, in particular, on a rear bumper. With the aid of the third distance sensor, a third distance from a water surface is measured, and with the aid of the fourth distance sensor, a fourth distance from a water surface is measured. A second, in particular longitudinal, component of the instantaneous flow velocity of the body of water forming the water surface is determined, as a function of the third distance, of the fourth distance and of the instantaneous pitch angle of the vehicle.

An absolute value of a component of the instantaneous flow velocity may, in particular, be determined by reading out a table, the table including respectively assigned velocity values for a multitude of combinations of measured values for the first distance and the second distance, and/or for a multitude of combinations of measured values for the third distance and the fourth distance and/or for a multitude of difference values of the distances. The absolute value of the component of the instantaneous flow velocity is, in particular, determined by correcting a velocity value assigned to the measured values for the first distance, the second distance and/or to the measured values for the third distance and the fourth distance, as a function of the instantaneous roll angle and/or of the instantaneous pitch angle.

The determined absolute value of at least one component of the instantaneous flow velocity may be compared to a velocity threshold value, and a warning may be output as a function of the comparison.

The velocity threshold value may be predefined as a function of an instantaneous fording depth and/or as a function of an instantaneous driving speed of the vehicle.

According to another aspect of the present invention, a computer program product including program code means for carrying out a method according to the present invention is provided, if the computer program product runs on a processing unit or is stored on a computer-readable data medium.

### BRIEF DESCRIPTION OF THE DRAWINGS

FIG. 1 schematically shows a vehicle while crossing a moving body of water in a top view.

FIGS. 2a and 2b schematically show a vehicle including a driver assistance system according to a first embodiment of the present invention while crossing a moving body of water in a front view.

FIG. 3 schematically shows a vehicle including a driver assistance system according to a second embodiment of the present invention while crossing a moving body of water in a side view.

FIG. 4 schematically shows a method according to the present invention in the form of a flow chart.

### DETAILED DESCRIPTION OF EXAMPLE EMBODIMENTS

In the following description of the exemplary embodiments of the present invention, identical elements are denoted by the same reference numerals, a repeated description of these elements being dispensed with, if necessary. The figures only schematically represent the subject matter of the present invention.

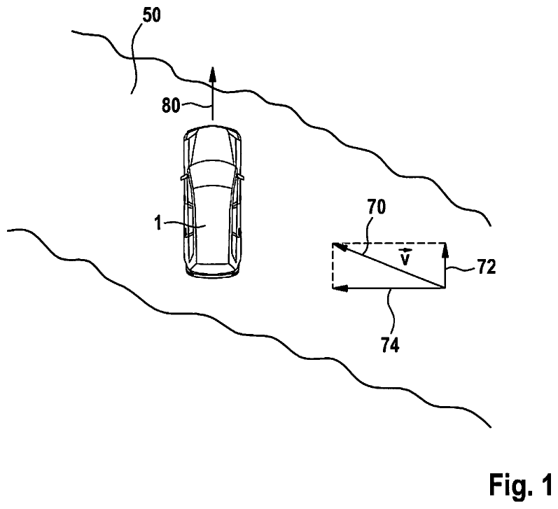

FIG. 1 shows a vehicle 1 in a top view, which is in the process of crossing a moving body of water 50, for example a river or a creek. Vehicle 1 is moving in driving direction 80. Flow velocity 70 of body of water 50 is a vector quantity which may be broken down into a longitudinal component 72, in parallel to driving direction 80 of the vehicle or to a geometric longitudinal axis of vehicle 1, and into a transversal component 74 orthogonal thereto, perpendicular to driving direction 80. The absolute values and directions of these two vector components of the flow velocity may be ascertained with the aid of the present invention.

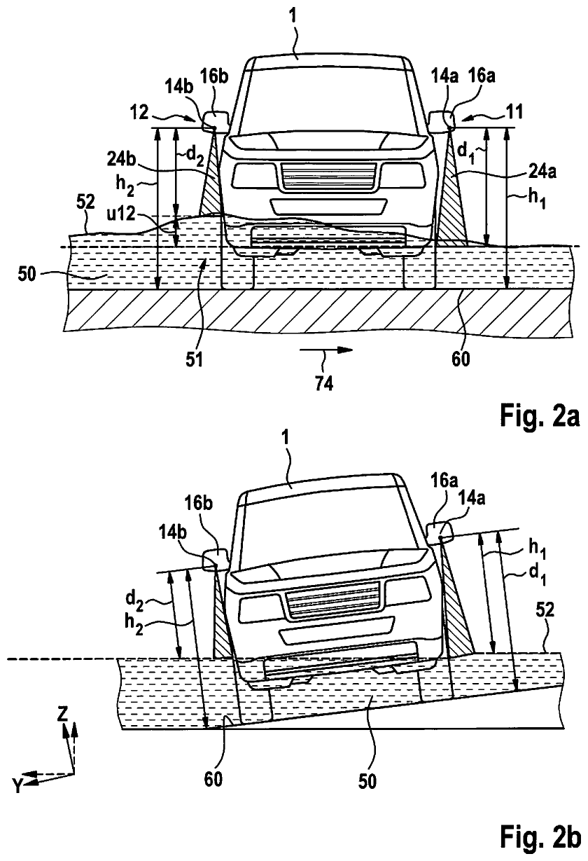

FIGS. 2a) and 2b) show a vehicle 1 including a driver assistance system according to a first embodiment of the present invention in two different situations.

FIG. 2a) shows vehicle 1 in a front view. Vehicle 1 is in a fording situation, i.e., it is negotiating a body of water 50. The vehicle is moving on a ground 60 flooded by water in such a way that at least portions of the front tires are situated below water surface 52. Body of water 50 has a current having a transversal component 74 of the flow velocity transversely to vehicle 1. The current causes water to be retained on side 12 of vehicle 1 facing the current, in area 51. This effect is utilized according to the present invention to determine transversal component 74 of the flow velocity. For this purpose, vehicle 1 on its side mirrors 16a and 16b includes a respective distance sensor 14a and 14b designed as an ultrasonic sensor. Distance sensors 14a and 14b are situated in such a way that their respective measuring areas 24a and 24b are essentially downwardly directed in the direction of water surface 52 directly beneath the respective side mirror 16a or 16b. Installation height h₁ of first distance sensor 14a is equal to installation height h₂ of second distance sensor 14b. First distance sensor 14a is thus designed to measure a first distance d₁ from water surface 52 on first side 11 of the vehicle, and second distance sensor 14b is designed to measure a second distance d₂ from water surface 52 on second side 12 of the vehicle. Since the existing current in area 51 on second side 12 of the vehicle results in a certain retention of the water, second distance sensor 14b in the shown situation measures a distance d₂ which is smaller than distance d₁ measured by first distance sensor 14a on first side 11. Since vehicle 1, in the shown situation, exhibits no lateral inclination (roll angle θ_{Roll}=0°), difference u₁₂ between measured first distance d₁ and measured second distance d₂ is directly attributable to the current, in particular to the component of the current perpendicular to the geometric longitudinal axis of vehicle 1 (transversal component). The determination of transversal component 74 of the flow velocity takes place with the aid of a processing unit (not shown), which is coupled to distance sensors 14a and 14b and a second measuring device for determining instantaneous roll angle θ_{Roll}, as a function of first distance d₁, of second distance d₂ and of instantaneous roll angle θ_{Roll} of vehicle 1.

FIG. 2b) shows a situation in which vehicle 1 is traveling on a ground 60 inclined perpendicularly to the vehicle longitudinal axis. This results in a roll angle, θ_{Roll}≠0°, in this example θ_{Roll}>0°. To determine the transversal component of the flow velocity, roll angle θ_{Roll} is determined with the aid of a suitable sensor (not shown), for example an acceleration sensor or a spirit level and taken into consideration in the determination of the transversal component of the flow velocity.

To find out in which direction the flow velocity is maximal, the orientation of the vehicle may be varied, and the transversal component of the flow velocity may be continuously determined in the process. As soon as vehicle 1 has changed its driving direction once by at least 180°, the orientation of the vehicle in which the absolute value of the transversal component of the flow velocity assumes its maximum may be determined via the progression of the measured transversal component of the flow velocity. The associated orientation of the vehicle is then perpendicular to the flow direction.

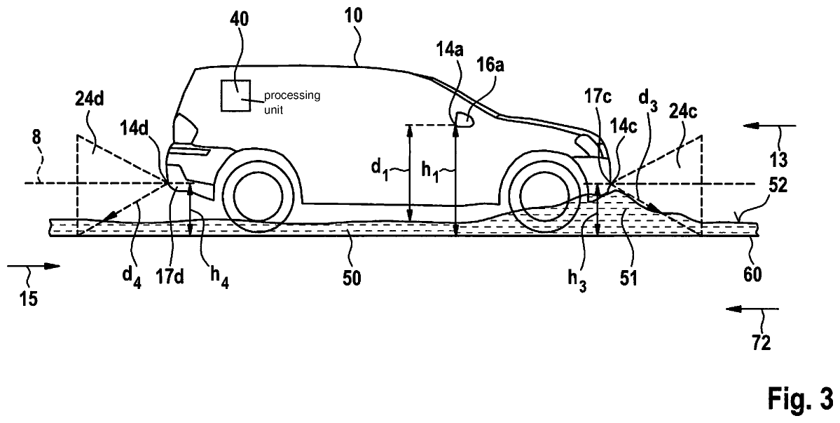

In particular in shallow bodies of water, additional distance sensors 14c and 14d, which are situated on the front and rear bumpers of the vehicle, may be used to directly determine a second, in particular longitudinal, component of the instantaneous flow velocity of the body of water. FIG. 3 shows a vehicle 10 thus equipped in a side view.

Vehicle 10 includes a driver assistance system according to the illustration in FIG. 2 for determining transversal component 74 of the flow velocity. Vehicle 10 is in a fording situation, i.e., it is situated in a body of water 50. The vehicle is standing in this case on a ground 60 flooded by water in such a way that at least portions of the tires are situated below water surface 52. Body of water 50 has a current having a longitudinal component 72 of the flow velocity along vehicle 10. The current causes water to be retained on side 13 of vehicle 10 facing the current, in area 51. This effect is utilized according to the present invention to determine longitudinal component 72 of the flow velocity. For this purpose, vehicle 10 also includes on its bumpers 17c on the front and 17d on the rear in each case a distance sensor 14c and 14d designed as an ultrasonic sensor. Distance sensors 14c and 14d are situated in such a way that their respective measuring areas 24c and 24d are oriented obliquely downwardly directed in the direction of water surface 52 in front of or behind vehicle 10. Installation height h₃ of third distance sensor 14c in this example is equal to installation height h₄ of fourth distance sensor 14d. Third distance sensor 14c is thus designed to measure a third distance d₃ from water surface 52 in front of vehicle 10, and fourth distance sensor 14d is designed to measure a fourth distance d₄ from water surface 52 behind vehicle 10. Since the existing current in area 51 in front of the vehicle results in a certain retention of the water, third distance sensor 14c in the shown situation measures a distance d₃ which is smaller than distance d₄ measured by fourth distance sensor 14d behind the vehicle. Since vehicle 10, in the shown situation, exhibits no longitudinal inclination (pitch angle θ_{Pitch}=0°), and additionally is not moving, difference u₃₄ between measured third distance d₃ and measured fourth distance d₄ is directly attributable to the current, in particular to the component of the current in the direction of geometric longitudinal axis 8 of vehicle 10 (longitudinal component). The determination of longitudinal component 72 of the flow velocity takes place with the aid of a processing unit 40, which is additionally coupled to third distance sensor 14c and fourth distance sensor 14d, and of a measuring device for determining instantaneous pitch angle θ_{Pitch} of vehicle 10, as a function of third distance d₃, of fourth distance d₄ and of instantaneous pitch angle θ_{Pitch} of vehicle 10.

As an alternative or in addition, sensors 14c and 14d may be designed to detect whether or that an immersion of the respective sensor has taken place. This may take place, for example, by detecting a characteristic signal of an ultrasonic sensor, which is generated when a membrane of the ultrasonic sensor makes contact with a water surface or is situated under water. If it is detected, for example, that third sensor 14c is already in contact with the water surface or is already immersed, while fourth sensor 14d still has no contact with water, a current in the direction of geometric longitudinal axis 8 of vehicle 10 (longitudinal component) may be inferred when the installation heights of sensors 14c and 14d are known.

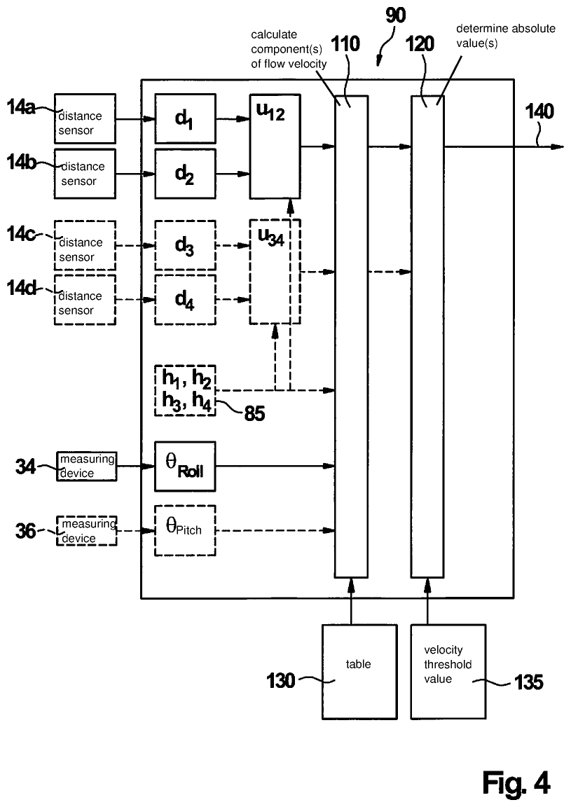

FIG. 4 shows a block diagram of procedure 90 of a method according to the present invention, for example, for executing a computer program on a processing unit 40 of a driver assistance system according to the present invention. With the aid of distance sensors 14a and 14b, distance signals d₁ and d₂ are generated, which describe the distance of the respective sensor 14a and 14b from the water surface. These may be results from individual measurements or, for example, average values from multiple measurements. Optionally, with the aid of further distance sensors 14c and 14d, distance signals d₃ and d₄ are also generated, which describe the distance of the respective sensor 14c and 14d from the water surface. These may, in turn, be results from individual measurements or, for example, average values from multiple measurements. A difference value u₁₂ is formed from distance signals d₁ and d₂. Optionally, a difference value u₃₄ is formed from distance signals d₃ and d₄. If necessary, predefined installation heights h₁, h₂, h₃, h₄ and other known geometric quantities 85 of the vehicle may be considered in the calculation of difference values u₁₂ or u₃₄. With the aid of difference value u₁₂ and of a roll angle θ_{Roll} determined by a suitable measuring device 34, a first component of the flow velocity is calculated in program step 110. For this purpose, a table 130 is also polled, in which flow velocity values assigned to various values of u₁₂ in a vehicle-specific manner are stored. Optionally, with the aid of difference value u₃₄ and a pitch angle θ_{Pitch} optionally determined by a suitable measuring device 36, a second component of flow velocity is also calculated in program step 110. For this purpose, flow velocity values assigned to various values of u₃₄ in a vehicle-specific manner are additionally stored in table 130.

In program step 120, the absolute value of the first determined component and optionally the absolute value of the second determined component of the flow velocity are each compared to a velocity threshold value 135. The velocity threshold value may be predefined as a function of an instantaneous fording depth and/or of an instantaneous driving speed and/or of further driving dynamics variables.

A piece of warning information 140 is output as a function of the comparison result. For example, at a water depth or fording depth of 15 cm, a flow velocity, in particular, transversely to the vehicle, of 30 km/h may be predefined as the velocity threshold value. In contrast, at a water depth or fording depth of 80 cm, a flow velocity, in particular, transversely to the vehicle, of only 5 km/h may be predefined as the velocity threshold value. As an alternative or in addition, the velocity threshold value may be varied as a function of an instantaneously measured wheel slip. A high wheel slip indicates a ground surface having low friction. In the case of ground surfaces having low friction, the risk of vehicle 1 being swept away by the current may be increased. On the other hand, the current may also be utilized to minimize the slippage of the vehicle on a ground surface having low friction. When the flow direction and flow velocity are known, vehicle 1 may be oriented in such a way that the vehicle offers preferably little resistance to the current. For example, the front of the vehicle, which usually has a lower flow resistance than a lateral surface 11, 12, may be oriented counter to the flow direction. Similarly, as an alternative, the rear could also be oriented counter to the flow direction.

What is claimed is:

1. A driver assistance system configured to determine a fording situation of a vehicle, comprising:
a first measuring device configured to determine distances from a water surface, including at least two distance sensors, a first distance sensor of the at least two distance sensors being configured to be situated laterally with respect to a first side of the vehicle, and a second distance sensor of the at least two distance sensors being configured to be situated laterally with respect to a second side of the vehicle, the second side being situated opposite the first side, and the first distance sensor being configured to measure a first distance from a water surface, and the second distance sensor being designed to measure a second distance from the water surface;
a second measuring device configured to determine an instantaneous roll angle of the vehicle;
a processing unit, coupled to the first measuring device and the second measuring device, configured to determine at least one first transversal component of an instantaneous flow velocity of a body of water forming the water surface, as a function of the first distance, of the second distance, and of the instantaneous roll angle of the vehicle.

2. The driver assistance system as recited in claim 1, wherein the driver assistance system additionally includes a third measuring device configured to determine an instantaneous pitch angle of the vehicle, the processing unit being coupled to the third measuring device and configured to determine at least one component of the instantaneous flow velocity as a function of the instantaneous pitch angle of the vehicle.

3. The driver assistance system as recited in claim 1, wherein the first measuring device additionally includes a third distance sensor and a fourth distance sensor, the third distance sensor being configured to be situated on a front bumper of the vehicle, and the fourth distance sensor being configured to be situated on a rear bumper of the vehicle, the third distance sensor being configured to measure a third distance from the water surface, and the fourth distance sensor being configured to measure a fourth distance from a water surface, and the processing unit being configured to determine a second longitudinal component of the instantaneous flow velocity as a function of the third distance, of the fourth distance and of the instantaneous pitch angle of the vehicle.

4. The driver assistance system as recited in claim 3, wherein the driver assistance system further includes a memory unit, which includes a table in which respectively assigned velocity values are stored for a multitude of combinations of measured values for the first distance and the second distance and/or for a multitude of combinations of measured values for the third distance and the fourth distance and/or for a multitude of difference values of the first, second, third and fourth distances, the table being specific to a certain vehicle type.

5. The driver assistance system as recited in claim 1, wherein the driver assistance system includes a warning unit, the processing unit being configured to compare an absolute value of at least one component of the instantaneous flow velocity to a velocity threshold value, and the warning unit being configured to output a warning as a function of the comparison.

6. The driver assistance system as recited in claim 5, wherein the velocity threshold value is predefined as a function of an instantaneous fording depth and/or as a function of an instantaneous driving speed and/or as a function of an instantaneous driving direction of the vehicle and/or as a function of an instantaneous wheel slip.

7. The driver assistance system as recited in claim 1, wherein the first and second distance sensors are each ultrasonic sensors.

8. A vehicle comprising:
a vehicle assistance system configured to determine a fording situation of a vehicle, comprising:
a first measuring device configured to determine distances from a water surface, including at least two distance sensors, a first distance sensor of the at least two distance sensors situated laterally with respect to a first side of the vehicle, and a second distance sensor of the at least two distance sensors situated laterally with respect to a second side of the vehicle, the second side being situated opposite the first side, and the first distance sensor being configured to measure a first distance from a water surface, and the second distance sensor being designed to measure a second distance from the water surface;
a second measuring device configured to determine an instantaneous roll angle of the vehicle;
a processing unit, coupled to the first measuring device and the second measuring device, configured to determine at least one first transversal component of an instantaneous flow velocity of a body of water forming the water surface, as a function of the first distance, of the second distance, and of the instantaneous roll angle of the vehicle.

9. The vehicle as recited in claim 8, wherein the first distance sensor and the second distance sensor are each situated on a side mirror of the vehicle.

10. A method for determining a fording situation of a vehicle, wherein the vehicle includes a first measuring device for determining distances from a water surface, including at least two distance sensors, a first distance sensor of the at least two distance sensors being situated laterally with respect to a first side of the vehicle, and a second distance sensor of the at least two distance sensors situated laterally with respect to a second side of the vehicle, the second side being situated opposite the first side, and the vehicle including a second measuring device configured to determine an instantaneous roll angle of the vehicle, the method comprising:
measuring a first distance from a water surface using the first distance sensor;
measuring a second distance from the water surface using the second distance sensor;
determining at least one first transversal component of an instantaneous flow velocity of a body of water forming the water surface as a function of the first distance, the second distance, and the instantaneous roll angle of the vehicle.

11. The method as recited in claim 10, wherein the vehicle includes a third measuring device for determining an instantaneous pitch angle of the vehicle, at least one component of the instantaneous flow velocity being determined as a function of the instantaneous pitch angle.

12. The method as recited in claim 11, wherein the first measuring device includes a third distance sensor and a fourth distance sensor, the third distance sensor being situated on front bumper of the vehicle, and the fourth distance sensor being situated on a rear bumper of the vehicle, a third distance from the water surface being measured using the third distance sensor, and a fourth distance from the water surface being measured using the fourth distance sensor, and a second longitudinal component of the instantaneous flow velocity of the body of water forming the water surface being determined as a function of the third distance, the fourth distance, and the instantaneous pitch angle of the vehicle.

13. The method as recited in claim 12, wherein an absolute value of a component of the instantaneous flow velocity is determined by reading out a table, the table including respectively assigned velocity values for a multitude of combinations of measured values for the first distance and the second distance and/or for a multitude of combinations of measured values for the third distance and the fourth distance and/or for a multitude of difference values of the first, second, third and fourth distances, the absolute value of the component of the instantaneous flow velocity being determined by correcting a velocity value assigned to the measured values for the first distance, and the second distance and/or the measured values for the third distance and the fourth distance, as a function of the instantaneous roll angle and/or of the instantaneous pitch angle.

14. The method as recited in claim 11, wherein an absolute value of at least one component of the instantaneous flow velocity is compared to a velocity threshold value, and a warning is output as a function of the comparison.

15. The method as recited in claim 14, wherein the velocity threshold value is predefined as a function of an instantaneous fording depth and/or as a function of an instantaneous driving speed of the vehicle.

16. A non-transitory computer-readable data medium on which is stored a computer program product including program for determining a fording situation of a vehicle, wherein the vehicle includes a first measuring device for determining distances from a water surface, including at least two distance sensors, a first distance sensor of the at least two distance sensors being situated laterally with respect to a first side of the vehicle, and a second distance sensor of the at least two distance sensors situated laterally with respect to a second side of the vehicle, the second side being situated opposite the first side, and the vehicle including a second measuring device configured to determine an instantaneous roll angle of the vehicle, the program, when executed by a processing unit, causing the processing unit to perform:
measuring a first distance from a water surface using the first distance sensor;
measuring a second distance from the water surface using the second distance sensor;
determining at least one first transversal component of an instantaneous flow velocity of a body of water forming the water surface as a function of the first distance, the second distance, and the instantaneous roll angle of the vehicle.
